(19) United States
(12) Patent Application Publication
(10) Pub. No.: US 2004/0171726 A1
(43) Pub. Date: Sep. 2, 2004

(54) Stabilized aqueous dispersion of fluoropolymer

(76) Inventors: Luk Germain Pierre Joseph D'Haenens, Gent (BE); Dipti Dilip Khasnis, Wilmington, DE (US); Walter Andre Jules Stoks, Rijmenam (BE)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/760,338

(22) Filed: Jan. 20, 2004

Related U.S. Application Data
(60) Provisional application No. 60/444,426, filed on Feb. 3, 2003.

(51) Int. Cl. C08K 5/24

(52) U.S. Cl. 524/261; 524/805

(57) ABSTRACT

The present invention relates to a stabilized fluoropolymer aqueous dispersion, wherein the stabilizer is polysiloxane polyoxyethylene copolymer preferably having a cloud point of no greater than 25° C.

### BACKGROUND OF THE INVENTION

1. Field of the Invention

This invention relates to the stabilization of aqueous dispersions of fluoropolymer.

2. Description of Related Art

Aqueous dispersions of fluoropolymer are made by the well-known method of polymerizing the fluoromonomer(s) in an aqueous medium containing polymerization initiator and dispersing agent, such as ammonium perfluorocarboxylate. The average particle size of the resulting fluoropolymer is generally from 0.05 to 0.5 micrometer, and the fluoropolymer concentration in the aqueous medium is generally from 20-55 wt %, based on the total weight fluoropolymer plus aqueous medium. While the resultant aqueous dispersion has some stability, if subjected to shear such as by shaking or vigorous stirring, it typically coagulates, wherein the dispersed fluoropolymer particles irreversibly bind together, rendering the resulting mixture of coagulum and aqueous medium useless for dispersion coating application. The same is true if the dispersed fluoropolymer particles settle during storage, this settling being the coagulation of the fluoropolymer particles.

To prevent premature coagulation during storage and handling, stabilizers have been added to the aqueous dispersion, the stabilizer having a hydrophobic portion which is attracted to the fluoropolymer particles and a hydrophilic portion which renders the stabilizer entirely water soluble at least at temperatures up to 25° C. at stabilizer concentration levels. U.S. Pat. No. 3,037,953 discloses polyethylene oxide of octyl phenol, sometimes referred to as octyl phenol ethoxylate, commonly available as Triton® X-100 surfactant, available from Dow Chemical, as the stabilizer, having a cloud point of 50-80° C. Cloud point is the temperature above which the stabilizer becomes insoluble in the aqueous medium, as indicated by the stabilizer forming tiny droplets within the aqueous medium, i.e. the aqueous medium becomes turbid, this turbidity being caused by an insoluble amount of the stabilizer becoming visible to the naked eye. Just below the cloud point, the stabilizer is completely soluble in the aqueous medium in the concentrations used for stabilizing. Above the cloud point, only a very small amount of the stabilizer may be soluble. U.S. Pat. No. '953 uses the formation of the cloud point as a way of concentrating the aqueous dispersion to a higher solids content, by enabling the formation of a solids free supernate which can then be decanted. Some stabilizer remains with the dispersed fluoropolymer particles to continue stabilizing the more concentrated aqueous dispersion. U.S. Pat. No. 6,153,688 discloses the use of polyoxyethylene alkyl ether having a cloud point of over 45° C. as the stabilizer to provide storage stability of the dispersion at 25° C. and to enable the dispersion to be concentrated. At warm temperatures, e.g. 35-40° C., such as may be encountered during several months storage, much of the dispersed fluoropolymers settle irreversibly, i.e. they coagulate, and cannot be redispersed.

The Triton® surfactant has remained the stabilizer of choice. U.S. Pat. No. 6,153,688 associates the presence of the aromatic ring in decomposed products with air pollution.

### BRIEF SUMMARY OF THE INVENTION

The present invention involves the discovery of a new stabilizer for aqueous fluoropolymer dispersions, namely polysiloxane polyoxyalkylene copolymer, which does not have any aromatic ring. Thus, the present invention is a stabilized fluoropolymer aqueous dispersion, wherein the stabilizer is polysiloxane polyoxyethylene copolymer.

In a preferred embodiment of the present invention, the copolymer has a cloud point of a relatively low temperature, e.g. 25° C., and nevertheless the copolymer effectively stabilizes the aqueous fluoropolymer dispersion. The same is true for copolymer stabilizers having even lower cloud points, e.g. no greater than 20° C. or 15° C. The low cloud point of the copolymer stabilizer means that it is mostly insoluble in the aqueous medium at temperatures that are commonly encountered in the storage, shipping, and handling of the aqueous dispersion. Surprisingly, the copolymer stabilizes the dispersion, notwithstanding the insolubility of the copolymer as indicated by its low cloud point.

### DETAILED DESCRIPTION OF THE INVENTION

The aqueous fluoropolymer dispersion to be stabilized in accordance with the present invention can be made by conventional aqueous dispersion polymerization in which polymerization of the fluoromonomer(s) is initiated by the presence of polymerization initiator in the mildly agitated aqueous medium and the resultant colloidal-sized fluoropolymer particles are kept dispersed in the aqueous medium by the presence of dispersing agent in the aqueous medium. The literature is replete with description of fluoromonomers, initiators, dispersing agents, polymerization temperatures and pressures selected to obtain the particular polymerization result, e.g. fluoropolymer, colloidal particle size and shape, and fluoropolymer solids concentration in the aqueous medium, desired. The present invention is applicable to all of these polymerization recipes and systems. Typically, as described above, the fluoropolymer particles are colloidal in size, such as from 0.05 to 0.5 micrometers, these preferably being the average particle size of the fluoropolymer particles, and the solids concentration will be from 20 to 55 wt %, based on the total weight of the dispersion, prior to addition of the copolymer stabilizer to the dispersion.

The dispersing agent used in this process is preferably a fluorinated surfactant. Preferably, the dispersing agent is a perfluorinated carboxylic acid having 6-10 carbon atoms and is typically used in salt form. Suitable dispersing agents are ammonium perfluorocarboxylates, particularly ammonium perfluoroalkylcarboxylate, e.g., ammonium perfluorocaprylate or ammonium perfluorooctanoate.

Typically, no more than 0.5 wt % of dispersing agent is present in the aqueous dispersion, based on total weight of the fluoropolymer. The presence of the dispersing agent in the aqueous medium results in the polymerization process producing the aqueous dispersion of the fluoropolymer prior to the addition of the stabilizer in accordance with the present invention. Greater amounts of this dispersing agent are avoided because of their cost and the difficulty in removing them from baked coatings obtained from the dispersion. This dispersing agent, because of its small amount does not stabilize the dispersion after polymerization, when the dispersion is subjected to shear, which causes coagulation or from coagulation that just occurs upon standing in storage. Other well-known ingredients may be present in the polymerization medium during the polymerization process, such as wax and buffering agent.

The initiators preferably used in the process of this invention are free radical initiators. They may be those having a relatively long half-life, preferably persulfates, e.g., ammonium persulfate or potassium persulfate. To shorten the half-life of persulfate initiators, reducing agents such as ammonium bisulfite or sodium metabisulfite, with or without metal catalysis salts such as Fe (IlI), can be used.

In addition to the long half-life persulfate initiators preferred for this invention, small amounts of short chain dicarboxylic acids such as succinic acid or initiators that produce succinic acid such as disuccinic acid peroxide (DSP) may be also be added in order to reduce coagulum.

The fluoromonomer(s) present during the polymerization process along with the timing of their feed to the polymerization process are selected to produce the fluoropolymer in the aqueous dispersion desired. The fluoropolymer can be polytetrafluoroethylene (PTFE) having a melt viscosity of at least 1×10⁸ Pa·s at 380° C., which has the highest heat stability among the fluoropolymers. Such PTFE can also contain a small amount of comonomer modifier which improves film-forming capability during baking (fusing), such as perfluoroolefin, notably hexafluoropropylene (HFP) or perfluoro(alkyl vinyl) ether, notably wherein the alkyl group contains 1 to 5 carbon atoms, with perfluoro(ethyl or propyl vinyl ether) (PEVE or PPVE) being preferred. The amount of such modifier will be insufficient to confer melt-fabricability to the PTFE, generally being no more than 0.5 mole %. The PTFE may also be the micropowder-type of PTFE, wherein chain transfer agent is present in the aqueous polymerization medium to produce low molecular weight PTFE, characterized by a melt-viscosity of 0.1-100×10³ Pa·s at 372° C. Such PTFE is melt-flowable, but not melt-fabricable, i.e. when fabricated from the melt, the fabricated article of such PTFE lacks integrity and fractures either spontaneously or upon being subjected to slight stress.

While PTFE is a preferred fluoropolymer, the fluoropolymer component can also be melt-fabricable fluoropolymer. Examples of such melt-fabricable fluoropolymers include copolymers of tetrafluoroethylene (TFE) and at least one fluorinated copolymerizable monomer (comonomer) present in the polymer in sufficient amount to reduce the melting point of the copolymer substantially below that of PTFE homopolymer, e.g., to a melting temperature no greater than 315° C. Preferred comonomers with TFE include the perfluorinated monomers such as perfluoroolefins having 3-6 carbon atoms and perfluoro(alkyl vinyl ethers) (PAVE) wherein the alkyl group contains 1-5 carbon atoms, especially 1-3 carbon atoms. Especially preferred comonomers include hexafluoropropylene (HFP), perfluoro(ethyl vinyl ether) (PEVE), perfluoro(propyl vinyl ether) (PPVE) and perfluoro(methyl vinyl ether) (PMVE). Preferred TFE copolymers include FEP (TFE/HFP copolymer), PFA (TFE/PAVE copolymer), TFE/HFP/PAVE wherein PAVE is PEVE and/or PPVE and MFA (TFE/PMVE/PAVE wherein the alkyl group of PAVE has at least two carbon atoms). The molecular weight of the melt-fabricable tetrafluoroethylene copolymers is unimportant except that it be sufficient to be film-forming and be able to sustain a molded shape so as to have integrity, i.e. being melt-fabricable. Typically, the melt viscosity will be at least 1×10² Pa·s and may range up to about 60-100×10³ Pa·s as determined at 372° C. according to ASTM D-1238.

The dispersing agent maintains the fluoropolymer particles dispersed in the aqueous polymerization medium during polymerization, but this dispersing agent does not prevent coagulation of the fluoropolymer particles when the aqueous dispersion is subjected to sufficient shear such as is encountered in handling of the dispersion.

In accordance with the present invention, polysiloxane polyoxyalkylene copolymer, preferably having a low cloud point is added to the aqueous dispersion to accomplish the stabilization thereof. The polysiloxane portion of the stabilizer provides the hydrophobic portion of the stabilizer that is attracted to the dispersed fluoropolymer particles, and the oxyalkylene portion of the stabilizer provides the hydrophilic portion of the stabilizer enabling the stabilizer to be dispersed in the aqueous medium, the presence of these two portions enabling the stabilizer to function as such in the dispersion. The polysiloxane polyoxyalkylene copolymers used in the present invention are nonionic, i.e. are free of electrical charge, with the stabilization effect being achieved by the presence of the hydrophobic and hydrophilic portions of the stabilizer.

The stabilization achieved in the present invention in the practical sense enables the dispersion to be subjected to normal handling, including shipping, pumping, and vigorous stirring, without coagulation occurring. The same is true for storage stability of the dispersion; during storage at warm temperatures, e.g. 35-40° C., for several months, settling of the fluoropolymer particles may occur, but these settled particles are easily re-dispersible by mild agitation. The presence of the stabilizer prevents the settled particles from coagulating, thereby providing an advantage over the stabilizer of U.S. Pat. No. 6,153,688. That this stabilization is achieved can be predicted from a simple laboratory test (Stabilization Test), as follows: 200 g of aqueous fluoropolymer dispersion containing dispersing agent is added to a 400 ml plastic beaker having a height of 10 cm and a diameter of 8 cm (Tri-pour® beaker cat. #13915-657, VWR International, 3000 Hadley Rd., South Plainfield, N.J. 07080, USA). The beaker is equipped with a mechanically-driven stirrer having a propeller-type stirring blade. Specifically the mechanical stirrer is comprised of two parts: (1) a DBI Blade, part number MX-MP303 (available from the Paul N Gardner Company, Inc, 316 NE First Street, Pompano Beach, Fla. 33060, USA) and (2) a twelve inch shaft, part number MX-TS038 (also available from the Gardner Company). After the dispersion is added to the beaker, the blade is rotated at a speed of 500 rpm. The dispersion which does not contain stabilizer completely coagulates in 15 min. The dispersion, which contains stabilizer in accordance with the present invention, does not coagulate even after agitation (stirring) for at least 1 hr. The dispersion is considered stabilized, i.e. passing the Stabilization test, if no coagulation has occurred up to at least 1 hr agitation in the Stabilization Test. The Stabilization Test is conducted at 20° C. One indicium of lack of coagulation is that the stirring blade is not coated with fluoropolymer when removed from the beaker. If the fluoropolymer were coagulated, a coating of coagulum would form on the blade. Even though fluoropolymer is known for its non-stick property, the coagulum coating if formed sticks to the blade.

Notwithstanding that the polysiloxane polyoxyalkylene copolymer used in the present invention is only sparingly soluble at ambient temperatures, e.g. 15-25° C., as indicated by the low cloud point of the stabilizer, the stabilizer provides the stabilizing effect described above.

The particular identities of the polysiloxane moiety and the polyoxyalkylene moiety of the stabilizer are interdependent, i.e. the greater is the hydophobicity of the polysiloxane moiety, the greater is the hydophilicity required for the polyoxyalkyene moiety to achieve dispersability in the aqueous medium. The fewer the number of carbon atoms in the alkylene group, the greater the hydrophilicity. The preferred alkylene groups in the polyoxyalkylene moiety are ethylene and propylene. Such alkylene groups in a particular stabilizer can be either alkylene group or a mixture thereof.

The proportions of polysiloxane moiety and polyoxyalkylene moiety in the copolymer can also be described in terms of hydrophilic-lipophilic (hydrophobic) balance, commonly known as HLB. HLB is the wt % of the polyoxyalkylene moiety ÷5. The copolymer stabilizer used in the present invention preferably has an HLB of at least about 4, also giving the copolymer sufficient solubility to enter the aqueous medium so as to be able to come into contact with the hydrophobic surface of the dispersed fluoropolymer particles. Dispersability and solubility of the stabilizer increases with increasing HLB, such that a fine dispersion is achieved at an HLB of about 6-8, this fine dispersion being indicated by a milky appearance. Copolymers having an HLB of 8-10 form a stable dispersion of the stabilizer in the aqueous medium. With further increasing HLB, the solubility of the copolymer increases, until at an HLB of about 13, when the mixture of copolymer produces a clear solution in the aqueous medium. These dispersion results are obtained at 20° C. and may vary dependent on the particular makeup of the polysiloxane and polyoxyalkylene moieties. The preferred copolymer stabilizers used in the present invention will generally have an HLB of 5-10, preferably 5-8. The dispersability of the copolymer is best visualized in water, without any ingredients other than the copolymer present. The dispersability of the copolymer in water will be the same as in the aqueous fluoropolymer dispersion. The same is true for the visualizing of the cloud point of the copolymer.

Preferred polysiloxane polyoxyalkylene copolymer stabilizers used in the present invention are the block copolymers described by the following formula:

R′[(R₂SiO)_{y}]ₐ—[(CₙH₂ₙO)ₓ]_{b}R″, wherein R and R′ are hydrocarbyl groups, R″ is a hydrogen or a hydrocarbyl group, y is an integer of at least 2, a is an integer of at least 1, n is an integer of at least 2, x is an integer of at least 3, and b is an integer of at least 1.

The R, R′, and R″ hydrocarbyl groups are non-aromatic and are selected independent from one another. Even more preferably, R, R′ and R″ are independently methyl and ethyl, y is 2 or 3, a is 1 or 2, n is 2 to 4, x is at least 5, and more preferably 5 to 9, and b is 1 to 6. Preferred polysiloxane polyoxyalkylene copolymers used in the present invention decompose at temperatures no greater than 310° C. and more preferably at temperatures no greater than 300° C., so that upon baking a coating formed from the stabilized dispersion at temperatures above these temperatures, the stabilizer burns off, i.e. decomposes and volatizes from the coating.

The polysiloxane polyoxyalkylene copolymers used in the present invention are among those disclosed e.g. in U.S. Pat. No. 2,917,480. The polysiloxane polyoxyalkylene copolymers used in the present invention are also available commercially, e.g. as SILWET® surfactants from Crompton Corporation located in Greenwich, Conn.

The amount of stabilizer used in accordance with the present invention will vary with the fluoropolymer solids concentration in the dispersion and with the chemical identity of the polysiloxane polyoxyalkylene copolymer. Generally, however, the amount of stabilizer used will be that which is effective to provide the stabilization of said dispersion, i.e. to pass the Stabilization Test. The amount of such stabilizer present will typically be at least 2 wt % to provide sufficient stabilizing agent to coat the fluoropolymer particles. For the copolymer stabilizers that have a cloud point of no greater than 25° C. or lower cloud point, representing temperatures that are typically exceed in the storage, shipping or handling of the dispersion, the amount of stabilizer remaining in solution in the aqueous medium will be much less than the 2 wt % stabilizer concentration. Generally no more than 10 wt % is required to achieve the stabilization needed, without having any detrimental effect on the subsequent use of the dispersion. More typically, the copolymer concentration in the aqueous medium will be from 4 to 8 wt %, based on the weight of fluoropolymer in the dispersion.

The stabilizer is added to the aqueous dispersion of fluoropolymer which already contains dispersing agent (from the polymerization process) by simply adding the amount of stabilizer to the dispersion at room temperature (15-20° C.) and mildly stirring the resultant mixture. The stabilizer is a liquid and is easily dispersed with the aqueous medium.

The stabilized dispersion of the present invention is useful in the same manner as prior stabilized fluoropolymer aqueous dispersions. It can be used for coating applications as the dispersion compositions described above or mixed with other ingredients and then used for coating application. The stabilization of the dispersion in accordance with the present invention enables this mixing to be carried out without causing coagulation of the fluoropolymer in the dispersion.

### EXAMPLE

To a stirred dispersion of polytetrafluoroethylene (PTFE) homopolymer (393.1 gm) having a melt viscosity exceeding 10⁹ Pa·s at 372° C. containing 35 wt % PTFE solids obtained by polymerization of TFE in the presence of disuccinyl peroxide (DSP) and ammonium persulphate (APS) initiator and 0.1 wt. % ammonium perfluorooctanoate dispersing agent is slowly added polydimethyl siloxane polyethylene oxide (SILWET L-77®) stabilizer (6.9 gm, 5% based on solids) having a cloud point of less than 10° C. and an HLB of about 7. The stabilizer and dispersion are at about 20° C. Less than 0.1 wt % stabilizer remains dissolved in the aqueous medium because of the operating temperature being greater than the cloud point of the stabilizer. After mixing for 30 min, the stabilized dispersion was subjected to the Stabilization Test. The dispersion didn't coagulate even after agitation for 5 hr @ 500 rpm in accordance with the Test.

The PTFE dispersion described above, but without the copolymer stabilizer being added, when subjected to the Stabilization Test, coagulates completely in 15 minutes.

What is claimed is:

1. A stabilized fluoropolymer aqueous dispersion, wherein the stabilizer is polysiloxane polyoxyalkylene copolymer.

2. The dispersion of claim 1 wherein said copolymer is present in an effective amount to provide the stabilization of said dispersion.

3. The dispersion of claim 2 wherein the amount of said stabilizer present is at least 2% based on the total weight of said fluoropolymer.

4. The dispersion of claim 1 wherein said stabilizer has the formula R′[(R₂SiO)_{y}]ₐ—[(CₙH₂ₙO)ₓ]_{b}R″, wherein R and R′ are hydrocarbyl groups, R″ is a hydrogen or a hydrocarbyl group, y is an integer of at least 2, a is an integer of at least 1, n is an integer of at least 2, x is an integer of at least 3, and b is an integer of at least 1.

5. The dispersion of claim 1 wherein the concentration of said fluoropolymer in said dispersion prior to the addition of stabilizer thereto is from 20 to 55 wt % based on the total weight of said dispersion prior to addition of said stabilizer to said dispersion.

6. The dispersion of claim 5 wherein said dispersion also contains dispersing agent that provides said dispersion prior to the addition of said stabilizer to said dispersion.

7. The dispersion of claim 1 wherein said fluoropolymer is polytetrafluoroethylene.

8. The dispersion of claim 1 wherein said copolymer has a cloud point of no greater than 25° C.
